(19) United States
(12) Patent Application Publication
(10) Pub. No.: US 2011/0307847 A1
(43) Pub. Date: Dec. 15, 2011

(54) Hybrid system combining TLM simulators and HW accelerators

(75) Inventors: Hua-Shih Liao, Hsinchu City (TW); Yu-Xuan Lin, Dajia Township (TW); Xun-Wei Kao, Magong City (TW)

(73) Assignee: Global Unichip Corporation

(21) Appl. No.: 12/802,706

(22) Filed: Jun. 10, 2010

(51) Int. Cl. G06F 17/50

(52) U.S. Cl. 716/103

(57) ABSTRACT

A hybrid system is combining transaction level modeling (TLM) simulators and hardware accelerators so that new system-on chip (SoC) designs are integrated in a virtual platform (VP) to run TLM simulation and existent semiconductor intellectual properties (IP) are added to physical platform (PP) to run hardware accelerator. A new circuit design with TLM is easier to be performed than with register transfer language (RTL) and it is integrated in a virtual platform and existent IP doesn't have to be redesigned to be integrated in a virtual platform.

### BACKGROUND OF THE INVENTION

1. Field of the Invention

This invention relates generally to system level design methods for electronic systems-on a-chip (SoC) applications and relates more specifically to a hybrid system combining transactional level modeling (TLM) simulators with hardware accelerators.

2. Description of the Prior Art

Designs of systems-on a-chip (SoCs) are getting more and more complex. Reusable system blocks comprising generic gate net-lists are used often. The verification of such system blocks is very time-consuming and errors in the verification process can be extremely costly.

The design of a system block is usually tested using different models having different levels of abstraction. A transaction model, such as TLM model, based on a virtual platform with approximate cycles (TLM/CA) is often used initially, followed by a test and validation based on a physical level, having a lower level of abstraction and accurate cycles such as RTUCA.

For traditional application specific integrated circuits (ASIC) design flow, there is no efficient method to connect the RTUCA physical platform with the TLM/CX virtual platform. Pure RTUCA physical platform can't be verified by a test bench without simulator translation to RTUCA physical platform. Pure TLM/CX virtual platform can verify design early, but can't access to RTUCA physical platform without proper translation.

It would be desirable for the designers combining TLM simulators and hardware accelerators in order to accelerate simulation of complex system-on-chip simulation and to reduce significantly design overloads.

There are patents or patent publications known dealing with interactions between RTL and TLM:

U.S. Patent Application Publication (US 2007/0277144 to Veller et al.) teaches a system and method for converting an existing circuit description from a lower level description, such as RTL, to a higher-level description, such as TLM, while raising the abstraction level. By changing the abstraction level, the conversion is not simply a code conversion from one language to another, but a process of learning the circuit using neural networks and representing the circuit using a system of equations that approximate the circuit behavior, particularly with respect to timing aspects. A higher level of abstraction eliminates much of the particular implementation details, and allows easier and faster design exploration, analysis, and test, before implementation. In one aspect, a model description of the circuit, protocol information relating to the circuit, and simulation data associated with the lower level description of the circuit are used to generate an abstract model of the circuit that approximates the circuit behavior.

U.S. Patent (U.S. Pat. No. 6,845,341 to Beverly et al.) discloses a method and mechanism for performing improved performance analysis upon transaction level models. A system block may be modeled using transaction model at different levels of abstraction. A test bench may be used to apply a set of stimuli to a transaction model (e.g. a TLM model) and a RTL equivalent model, and store the resulting timing information into a database. The timing information stored in the database may be used to validate the performance of the transaction models and system block. The test bench may analyze transaction models in the TLM domain and the RTL domain through the employment of TVM (transaction verification models) which are components that maps the transaction-level requests made by a test stimulus generator to a detailed signal-level protocol on the RTL design.

U.S. Patent Application Publication (US 2008/0163143 to Soon-Wan Kwon) proposes a method for performing verification on a Transaction Level (TL) model having at least two abstraction levels in simulation modeling for design of a System-on-Chip (SoC). The TL model verification method includes acquiring first request information and first response information; acquiring second request information and second response information; dividing the first and second request information and the first and second response information; comparing the divided first and second request information and comparing the divided first and second response information; and verifying a modeling result on the TL model depending on the comparison results.

### SUMMARY OF THE INVENTION

A principal object of the present invention is to achieve a hybrid system combining TLM/CX virtual platform with RTUCA physical platform.

A further object of the present invention is to integrate new circuit designs in a virtual platform to run TLM simulations and to add semiconductor intellectual properties (IPs) to a physical platform to run hardware accelerators

A further object of the present invention is to enable an easier semiconductor circuit design.

Moreover another object Of the present invention is to reduce the RTUCA design time and chip costs.

Another object of the present invention is to accelerate physical platform verification

In accordance with the objects of this invention a method to combine a RTL physical platform and a TLM virtual platform has been achieved. The method invented comprises the following steps: (1) providing a hybrid system comprising a virtual platform proxy connected to a PC-system having a memory, and a packet transactor, wherein the packet transactor is connected to a test bench via a on-chip bus, (2) writing a transaction from the virtual platform to the on-chip bus, and (3) reading a transaction by the virtual platform proxy from the on-chip Bus.

In accordance with the objects of this invention a system combining a Register Transfer Level/Cycle Accurate (RTL/CA) physical platform with a Transaction Level Modeling/Cycle Approximate (TLM/CX) virtual platform providing an interface between both physical and virtual platforms in both directions in order to enable integration of new circuit designs in virtual platform to run TLM simulations and to add existent semiconductor soft properties (IP) to physical platform to run hardware acceleration has been achieved. The system invented firstly comprises: a physical bus connecting a device driver on the virtual platform with a packet transactor on the physical platform, said device driver connected further with a virtual platform proxy driver on the virtual platform, and said virtual platform proxy. Furthermore the system comprises said packet transactor on the physical platform translating RTUCA bus protocol to TLM/CX packet format.

### BRIEF DESCRIPTION OF THE DRAWINGS

In the accompanying drawings forming a material part of this description, there is shown:

FIG. 1 illustrates the hybrid system of the present invention, combining TLM/CX virtual platform and RTUCA physical platform

FIGS. 2a-b illustrate an Application Diagram between TLM/CX virtual platform and RTUCA physical platform

FIG. 3 shows the hybrid System Transmit Data Path

FIG. 4 depicts the hybrid System Transmit Data Path

FIG. 5 illustrates an embodiment of the hybrid system invented

FIG. 6 illustrates a PCI-to-AHB Transactor block diagram.

FIG. 7 illustrates a finite state machine (FSM) showing the states of direct memory access of the packet PCI-to AHB Transactor.

FIG. 8 illustrates a finite state machine (FSM) showing the states of READ direct memory access of the packet PCI-to-AHB transactor.

FIG. 9 depicts block diagram of the device driver.

FIG. 10 shows a block diagram of the virtual platform proxy.

FIG. 11 illustrates in detail the transaction packet format used in a preferred embodiment.

FIG. 12 illustrates a flowchart of a method invented to achieve an interface between a TLM/CX virtual platform and a RTUCA physical platform in both directions.

### DESCRIPTION OF THE PREFERRED EMBODIMENTS

The invention relates to a hybrid system combining a register transfer language with cycles accurate (RTUCA) physical platform and a transactional level modeling with cycles approximate (TLM/CX) virtual platform in order to simplify integrating System On Chip (SoC) designs. New circuit designs are integrated in a virtual platform (VP) to run TLM simulation and existent semiconductor intellectual properties (IP) are added to a physical platform (PP) to run hardware acceleration. A virtual platform can help physical platform verification and physical platform can access virtual platform design early to reduce the RTL design time and Field Programmable Gate Array (FGPA) chip cost.

The hybrid system invented connects the physical platform and the virtual platform through a physical bus interface such as USB I/F or PCI I/F. Accordingly, a packet transactor is added on the physical platform to translate RTUCA bus protocol to TLM/CX packet format and a device driver and a virtual platform proxy is built on a simulator machine on the virtual platform to connect a physical bus I/F and the virtual platform.

For System On Chip (SoC) verification, the simulation speed is slow to run related software application(s) in RTUCA simulation mode. Therefore, using the present invention, the TLM/CX simulator and HW accelerator can accelerate the simulation speed to verify complex SoC design.

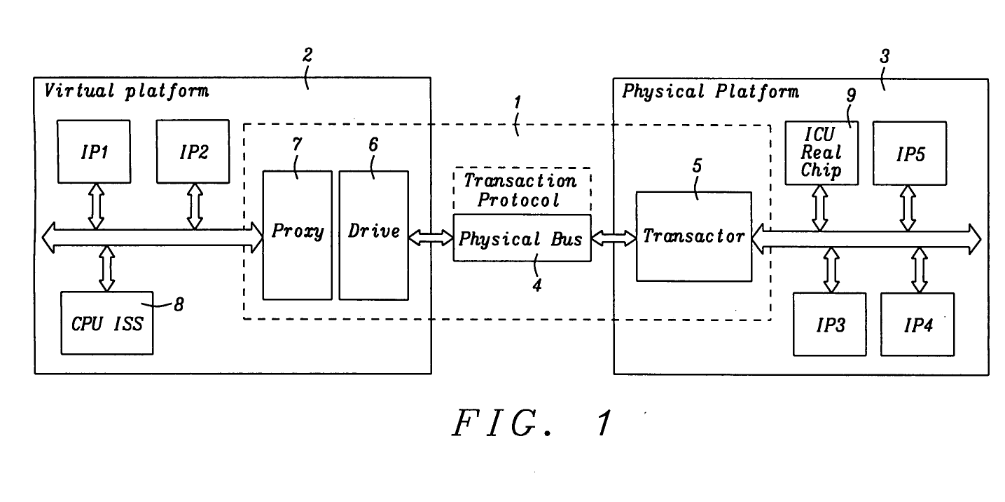

FIG. 1 shows a block diagram of the basic components of the hybrid system invented combining TLM simulators and hardware accelerators. It is a hybrid system because it comprises components on a virtual platform 2 with components on a physical platform 3. The hybrid system invented 1 combines a Transaction Level Modeling/Cycle Approximate (TLM/CX) virtual platform 2 with a Register Transfer Level/Cycle Accurate (RTUCA) physical platform 3. The hybrid system 1 invented comprises a physical bus I/F 4 connecting the virtual platform with a packet transactor 5 called “Bus_Xtor” located on the physical platform 3. The packet transactor 5, added on the physical platform 3, translates RTUCA bus protocol to TLM/CX packet format. The hybrid system invented 1 furthermore comprises a device driver 6 and a virtual platform proxy 7 built on a simulator machine to connect physical bus I/F 4 and the virtual platform 2. The data transfer through the physical bus 4 is following known transaction protocols.

Furthermore FIG. 1 illustrates on the virtual platform soft semiconductor intellectual property (IP) cores IP1 and IP2 and a high-level description of a design, such as an Instruction Set Simulator (ISS) model 8. On the physical platform, FIG. 1 shows a CPU test chip and semiconductor intellectual property (IP) cores IP3, IP4, and IP5.

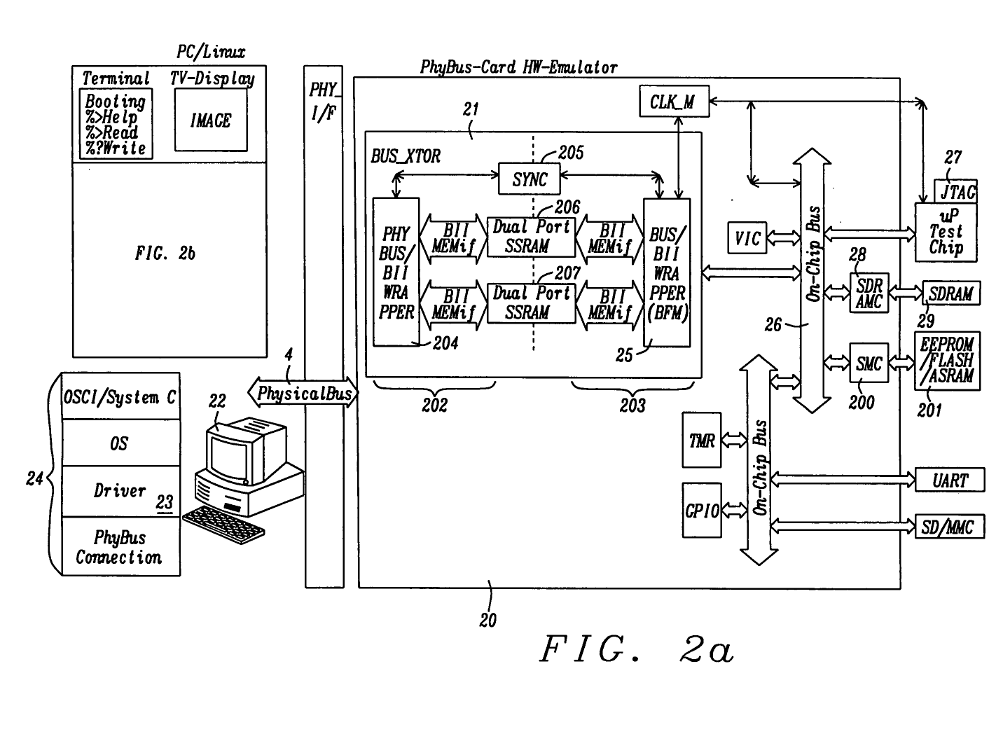

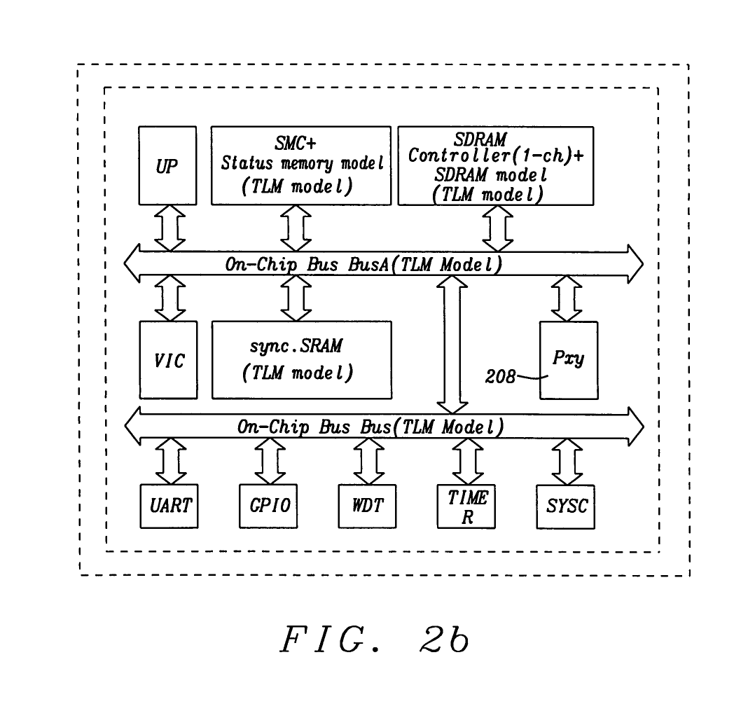

FIGS. 2a-b illustrate an application block diagram between TLM/CX virtual platform and RTUCA physical platform. A “BUS_XTOR” 21 is embedded in a HW-emulator card 20 to translate RTL/CA bus protocol to TLM/CX packet format. The “BUS_XTOR” 21 is a RTL code soft intellectual property core (IP). The virtual platform, PC/Linux has a device driver 23 to connect the physical bus I/F 4 and the virtual platform has proxy 208 to connect the virtual platform.

The “Bus XTOR” 21 as part of the present invention is embedded in a PCI Card HW emulator card 20. First a PCI Card HW emulator 20 is shown; this HW emulator could be e.g. a Field Programmable Gate Array (FPGA), comprising the “BUS_XTOR” 21 as part of the hybrid system of the present invention. The “BUS_XTOR” 21 is connected to a physical bus interface 4. The physical bus interface 4 is connected to a computer 22 running a TLM basic system 24. In a preferred embodiment of the invention computer 22 is a PC running LINUX as operating system. Other computer systems being capable to run a TLM basic system could be used as well.

Furthermore the “BUS_XTOR” 21 is connected via a Bus Independent Interface (BII) wrapper 25 and via an on-chip bus 26 to a μP test chip 27, via a SDRAM controller 28 to a SDRAM memory 29. Furthermore the “BUS_XTOR” is connected via a SMC card 200 to a non-volatile memory 201. The bus/BII WRAPPER 25 translates the TLM/CX packet format to RTUCA bus protocol.

The packet transactor “BUS_XTOR” 21 is divided into two parts, a Physical bus oriented part 202, and an on-chip bus oriented part 203. A PHY Bus wrapper 204 is a major part of the Physical bus oriented part 202. Three modules are common and connected to both Physical bus oriented part 202 and to on-chip bus oriented part 203, namely a synchronization module 205, synchronizing both parts 202 and 203, a dual port SSRAM memory 206, and a another dual port SSRAM memory 207. The two SSRAM memories 206 and 207 have different purposes. One SSRAM stores data from virtual platform that is called TXFIFO 32 as shown in FIG. 3. And the other SSRAM stores data from the physical platform that is called RXFIFO 41 as shown in FIG. 4.

Each of the SSRAM memories 206 and 207 has a BII memory interface to the physical bus wrapper 204 and to the on-chip bus BII wrapper 25 as well. The AHB BUS is one possible implementation of an ON-CHIP BUS.

The hybrid system invented comprises the packet transactor called “BUS_XTOR” 21, which is a soft semiconductor intellectual property (IP) core providing an interface to/from an on-chip bus as an advanced High-performance bus (AHB) and an interface to/from peripheral component interconnect (PCI) bus. The “BUS_XTOR” analyzes RTUCA bus protocol transactions and converts them to TLM/CX packet format transactions and converts TLM/CX TLM packet format transactions to RTUCA bus protocol transactions. The main functions include on-chip bus 26 interface, such as e.g. AHB side bus interface, PCI side direct memory access (DMA) engine and on-chip memory. The BUS_XTOR is fully compliant with AMBA 2.0, PCI 2.3 and earlier versions or PCI.

The “BUS_XTOR” can be used for multiple applications, e.g. Electronic System Level (ESL) top-down design flow, ASIC design verification, Field Programmable gate array (FPGA) prototype emulation, HW-SW co-simulation, or HW-SW co-debugging.

FIG. 3 depicts the detail path for transmissions of the hybrid system invented from system memory 30 of PC system 22 on the virtual platform to the on-chip Bus Wrapper 25. Same numerals are used in FIG. 2 if applicable. The information flow goes through following stations:

System Memory block 30 of PC system 22: prepared and stored Transmission (TX) packet from TLM/CX virtual platform and will let Phy. Bus Wrapper block 204 to read TX packet from system memory.

Phy. Bus Wrapper block 204: read data of TX packet from System Memory block and convert into DMA interface to TX DMA block.

TX DMA block 31: DMA (Direct Memory Access) to read TX packet through Phy. Bus Wrapper 204 and write TX packet into TXFIFO 32.

TxFIFO block 32: On-Chip Memory to store TX packet from TX DMA 31 and then read out by On-Chip Bus Wrapper 25.

On-Chip Bus Wrapper block 25: read out TX packet from TX FIFO 32 and generates On-Chip Bus interface protocol.

FIG. 3 depicts the detail path for reception of the hybrid system invented from on-chip Bus Wrapper 25 by system memory 30 of PC system 22 on the virtual platform to the on-chip chip Bus Wrapper 25. Same numerals are used in FIG. 2 if applicable. The information flow goes through following stations: from PC system 22 memory to on-chip Bus Wrapper 25, then to memory I/F 24, then to the module Reception (RX) FIFO 21 to handle reception of packets, and then to AHBII wrapper 25.

System Memory block 25: prepared and stored RX packet from RTUCA and will let Phy. Bus Wrapper block to write RX packet to system memory.

Phy. Bus Wrapper block 204: write data of RX packet to System Memory block and convert into DMA interface from RX DMA block.

RxDMA block 40: DMA (Direct Memory Access) read RX packet from RX FIFO and write RX Packet through Phy. Bus Wrapper block 204.

RxFIFO block 41: On-Chip Memory to store RX packet from On-Chip Bus

Wrapper and read out by RX DMA block.

On-Chip Bus Wrapper block 25: analyzed On-Chip Bus interface protocol and write RX packet to RX FIFO block 41.

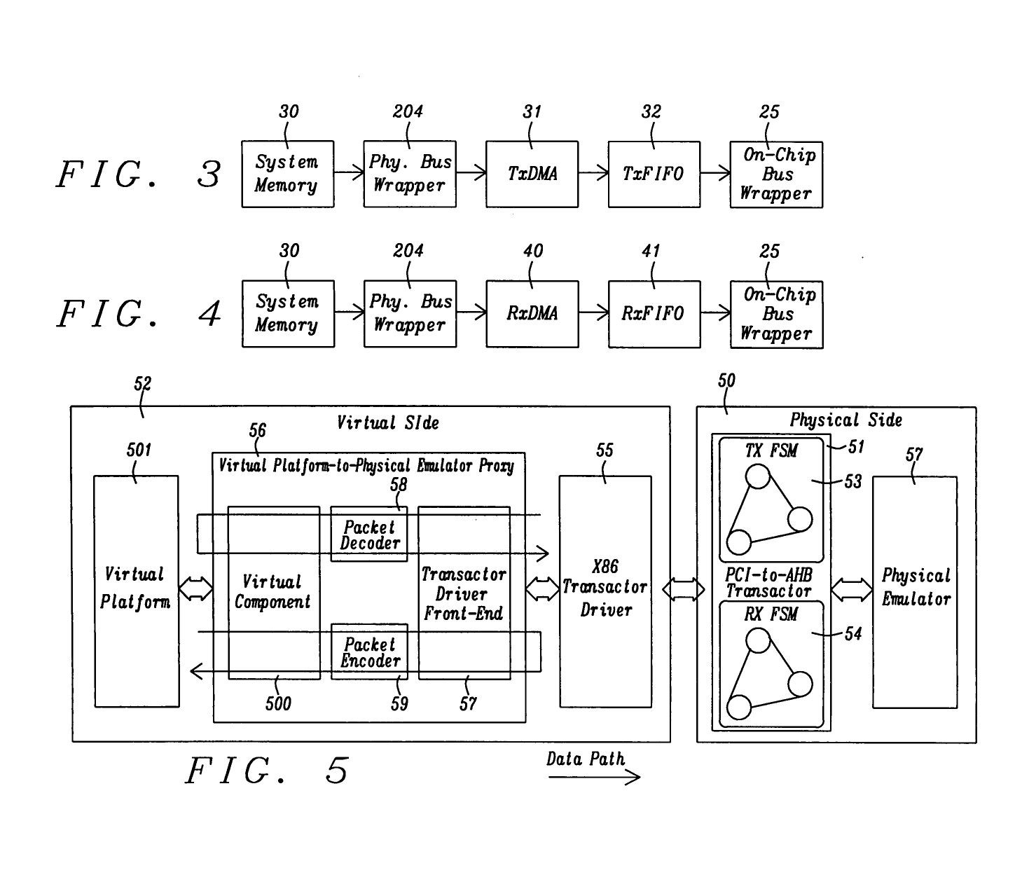

FIG. 5 depicts an embodiment of hybrid system invented. Physical platform 50 is an AMBA system with PCI bus interface and virtual side run 52 on X86 machine. In this preferred embodiment the BUS_XTOR 21 shown in FIG. 2 is a PCI-to-AHB transactor 50 having a transmission finite state machine (TX FSM) 53 and reception finite state machine 54 (RX FSM). A physical emulator 57 is connected to the PCI-to-AHB transactor 51 on the physical side 50. The embodiment of a device driver 6 of FIG. 1 is a X86 transactor driver 55 and the embodiment of a virtual platform proxy 7 of FIG. 1 is a virtual platform-to-physical emulator proxy 56. These two platforms communicate through PCI bus I/F. The proxy 56 comprises a transactor driver front-end 57, a packet decoder 58, a packer encoder 59, and a Virtual component 500, communicating with the virtual platform 501.

The data path is bidirectional. The arrow through Packet Encoder 59 is TX directional (virtual side to physical side) and the arrow through Packet Decoder 58 is RX directional (physical side to virtual side).

The Physical Emulator 57 comprises CPU test chip 9 and IPs 3-5 shown in FIG. 1

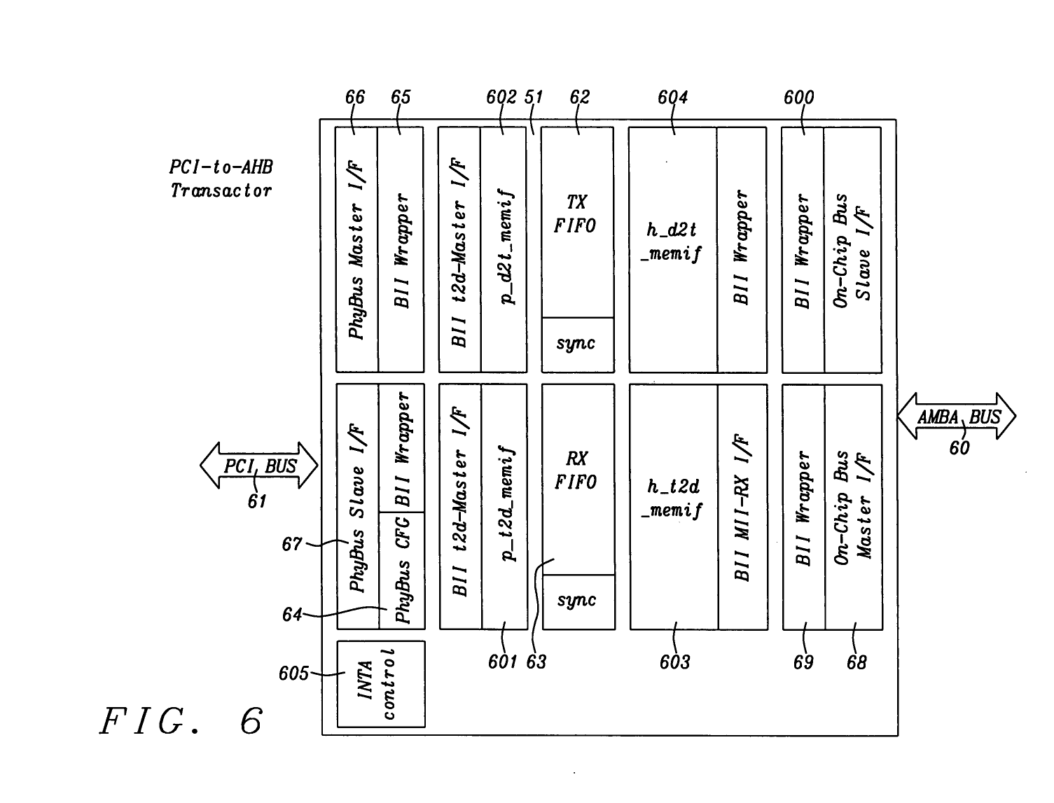

FIG. 6 depicts the block diagram of PCI-to-AHB Transactor 51 shown in FIG. 5. This transactor faces two kinds of interface: ON-CHIP BUS and PHYSICAL BUS. The ON-CHIP BUS interface can be any on-chip bus protocol and the PHYSICAL BUS interface can be any physical connection mechanism. In a preferred embodiment the ON-CHIP BUS is an AMBA BUS 60 and the Physical Bus is a PCI BUS 61.

The ON-Chip BUS 60 follows the AMBA Specification Revision 2.0 released by ARM Corporation. The PCI interface 61 is compliant with PCI Local Bus Specification 2.3 standard. The CSR is the Control and Status Register to configure the functionality of PCI-to-AHB Transactor 51 and to record the operation status. The direct memory access (DMA) controller transfers receive and transmit data directly from/to the system memory without processor intervention. In a preferred embodiment Internal FIFO size for transmit FIFO block 62 and for Receive FIFO block 63 is 128 Bytes, based on transaction packet format.

Furthermore the packet PCI-to-AHB Transactor 51 comprises the PCI/BII wrapper 65 for the PCI master I/F 66 and the PCI/BII wrapper 64 for the PCI slave I/F 67. Correspondently on the AHB side are the AHB/BII wrapper 69 for the AHB master I/F 68 and the AHB/BII wrapper 600 for the PCI slave I/F 601. Moreover the packet PCI-to-AHB Transactor 51 comprises a module TX FIFO 62 to handle transmission of packets and a module RX FIFO 63 to handle reception of packets. Memory interfaces 601, 602, 603 and 604 are deployed for transmission and reception of packets. A system controller 605 controls the operation of the packet transactor 51.

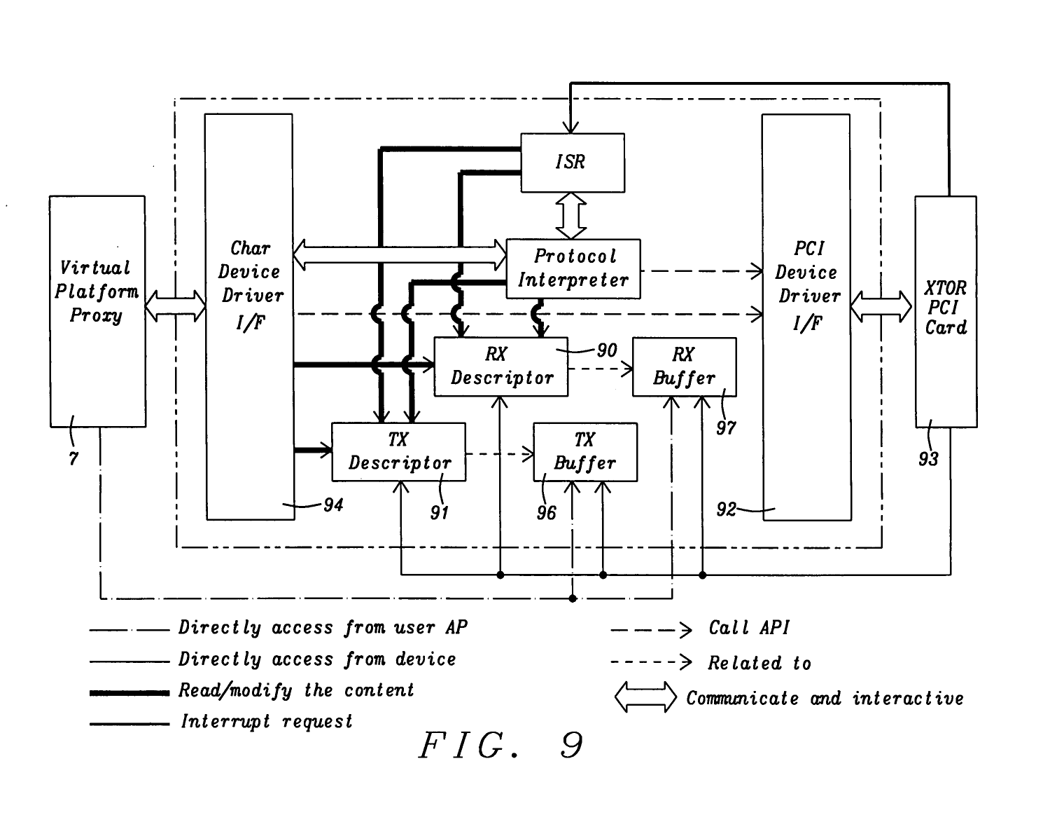

FIG. 7 illustrates a finite state machine (FSM) showing the states of direct memory access of the packet PCI-to AHB Transactor 5. FIG. 7 depicts that while in the running state, the driver 6, shown in FIG. 1, writes the non-zero value to polling register for packets requiring transmission. After polling starts, it continues in descriptor chained order (the descriptors are described in detail in FIG. 9). When it completes packet transmission, the transactor 5 writes back the final status information to the Tx descriptor. At this time, if interrupt on completion was set, the Tx interrupt is set, the next descriptor is fetched, and the process repeats.

The transmit process will be suspended if transactor detects a descriptor owned by the host. PCI-to-AHB transactor will resume if the driver give descriptor ownership to transactor and issue a poll demand command.

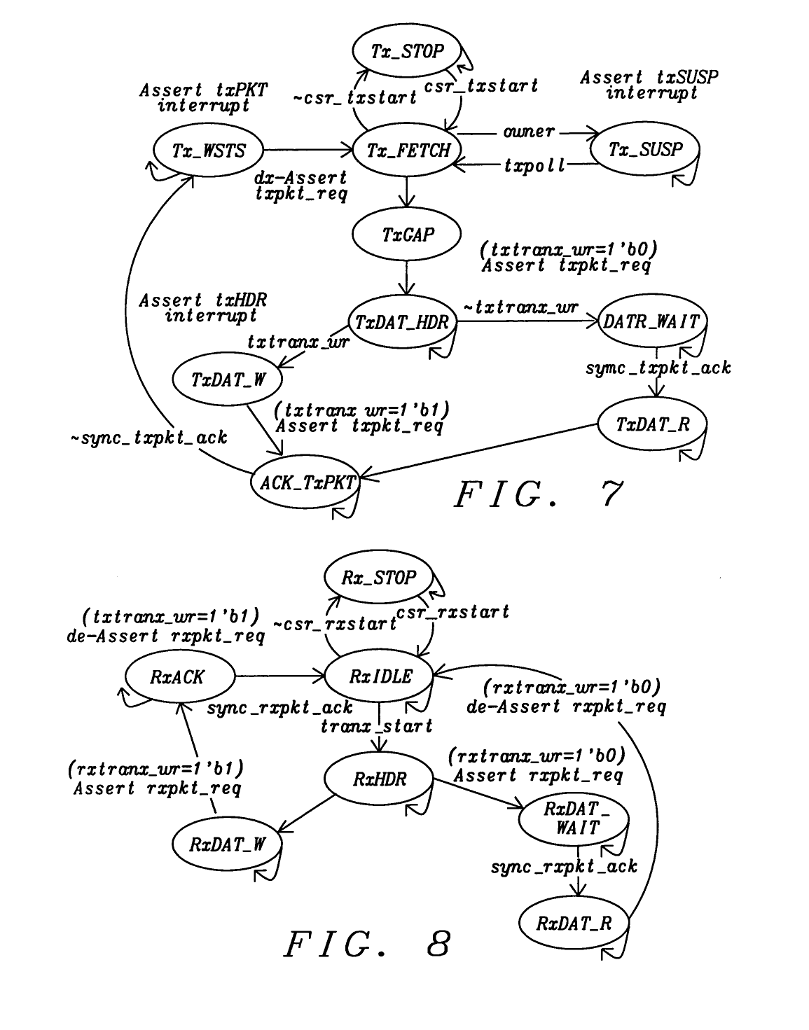

FIG. 8 illustrates a finite state machine (FSM) showing the states of READ direct memory access of the packet PCI-to-AHB transactor. FIG. 8 depicts that while in the running state, the receive process polls the Rx descriptor list. When the following conditions are satisfied, transactor attempts to acquire free descriptors:

When start/stop receive bit is set.

When transactor completes the reception of a packet, and the current Rx descriptor has been closed.

When the receive process is suspended because of an unavailable buffer and receive poll demand is issued.

FIG. 9 shows a device driver 6 block diagram. The device driver is part of the hybrid system 1 invented and has been shown already in FIG. 1. FIG. 9 illustrates the device driver 6 controls a PCI card and the virtual platform to access data through reception RX descriptor 90. PCI device driver I/F 92 controls Transactor PCI card 93 and Character device driver 94 controls virtual platform proxy 7. The transmission TX descriptor 91 and the transmission TX buffer 96 are used to switch data from virtual platform to physical platform. The RX descriptor 90 and the RX buffer 97 are used to switch data from physical platform to virtual platform.

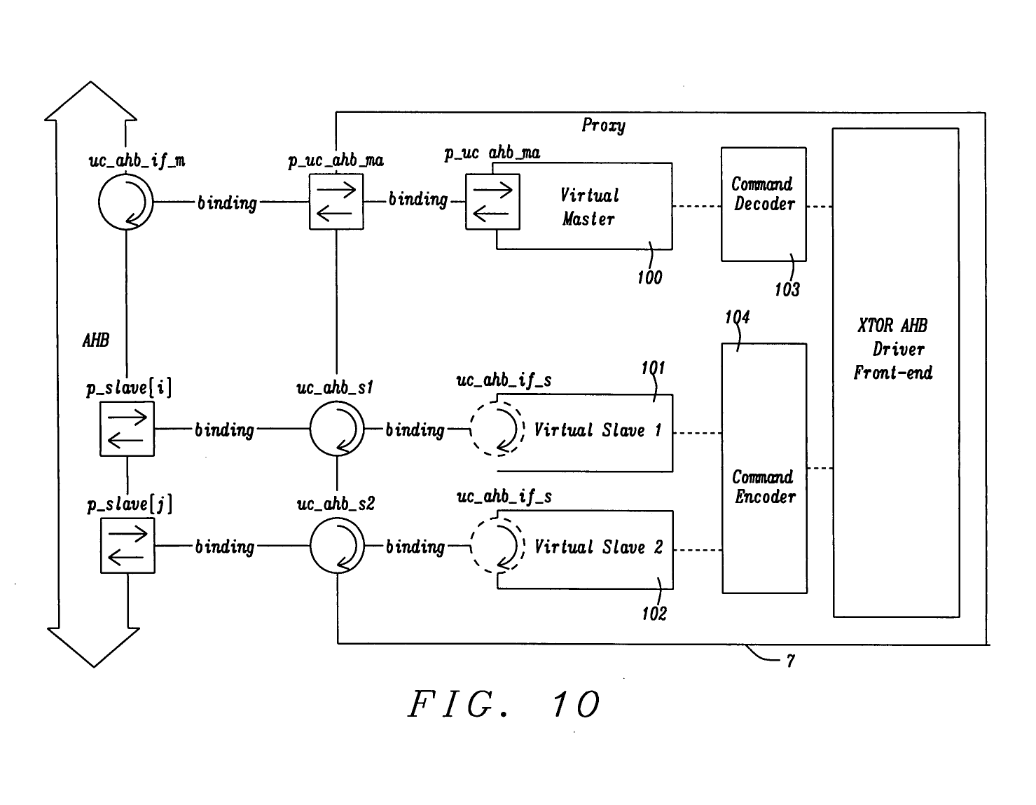

FIG. 10 shows a block diagram of the virtual platform proxy. The proxy 7 consists of a virtual master 100 and virtual slave 1 101 and virtual slave 2 102 binding to virtual platform used to switch data between virtual platform and TX/RX buffer. It should be noted that more than two virtual slaves are possible with the present invention. When the virtual master receives a TLM/CX transaction from command decoder 103 it is sent to virtual platform. When a virtual slave receives a virtual platform TLM/CX transaction it sends this transaction to command encoder 104 to translate it to a command. The virtual platform proxy 7 switches command via TX/RX buffers, shown in FIG. 9, through XTOR_AHB deriver front-end module. The command encoder 104 and command decoder 103 correspond to the packet encoder/decoder shown in FIG. 5.

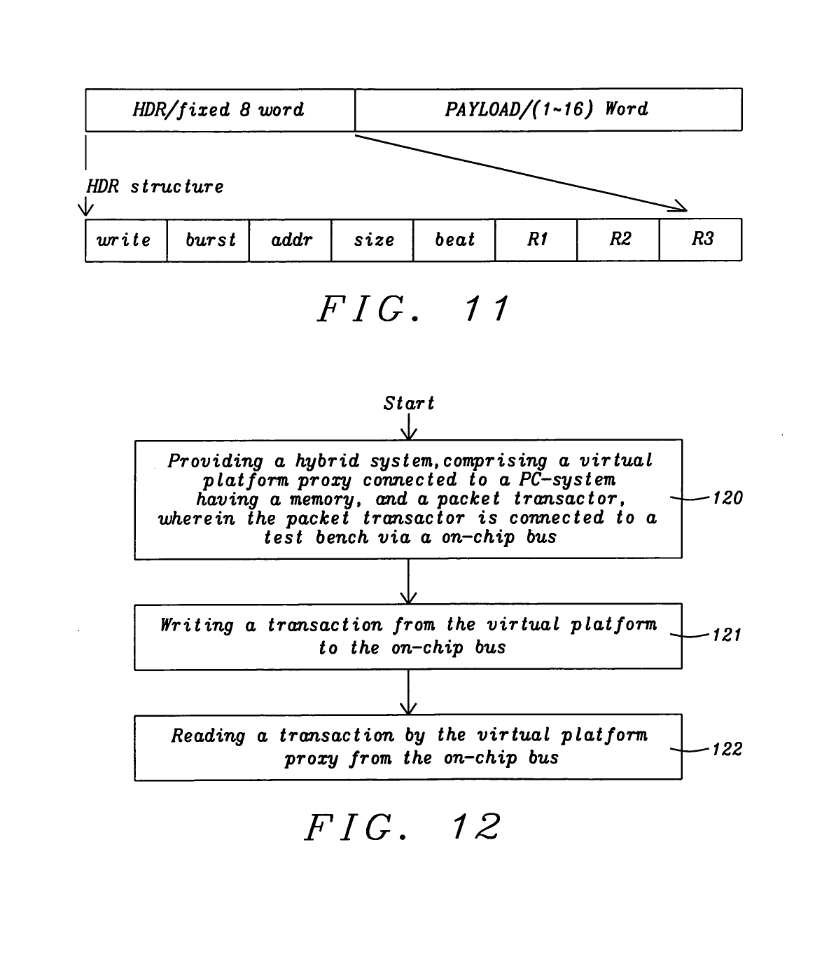

FIG. 11 illustrates in detail the transaction packet format used in a preferred embodiment; other formats would be possible as well. In a preferred embodiment a header comprises 8 words:
hdr.write : transaction read/write type.
hdr.burst: transaction burst type
hdr.addr: transaction address. It means transaction start address.
hdr.size: transaction byte lane.
hdr.beat: transaction transfer beats. It indicates transfer beats count in transaction.
hdr.r1: Reserved.
hdr.r2: Reserved.
hdr.r3: Reserved.

Described below are examples of read/write transactions:

A. Directions of TRANSMIT Transactions (from Virtual Platform to Physical Platform):

1. Write Transaction:
Virtual platform writes a transaction to physical platform:

The virtual platform proxy receives a write transaction from virtual platform, writes then HDR and PAYLOAD data into Tx buffer. The device driver controls PCI BUS side of XTOR to access this packet from Tx buffer and stores it into internal memory.

The PCI BUS side of XTOR will then read HDR and PAYLOAD data from Tx buffer to internal memory and requests AMBA BUS side of XTOR to complete write transaction.

2. Read Transaction:
Virtual platform requests a read transaction from physical platform:

The virtual platform proxy receives a read transaction from virtual platform, writes then the HDR into Tx buffer. The device driver controls PCI BUS side of XTOR to access this packet from Tx buffer and stores it into internal memory.

The PCI BUS side of XTOR reads then HDR from Tx buffer to internal memory and requests AMBA BUS side of XTOR to read back PAYLOAD from physical platform. After reading back PAYLOAD data, PCI BUS side of XTOR reads internal memory to put data into Tx buffer.

The device driver will control virtual platform proxy to read PAYLOAD from Tx buffer and completes read transaction.

Transaction address TxDES has to be prepared first, and then HDR structure has to be prepared and then address TxDES.tdes0.own has to be set into “1′b1” to indicate XTOR of physical platform that Tx packet is prepared ready. After transmit data are prepared, XTOR of physical platform must be kicked-off to poll TxDES again to transmit transaction. After transaction is completed, XTOR of physical platform writes back status into TxDES.tdes0.

The TX Descriptor 91 shown in FIG. 9 is shortened to “TxDES”. And we chained two TX descriptors to complete information translation between virtual side and physical side. So the “TxDES.tdes0” is defined the first TX descriptor. Descriptor is used to translate information between virtual side and physical side. The owner bit in descriptor is defined the ownership of descriptor. The owner bit of the first TX descriptor is shortened to “TxDES.tdes0.own”.
B. Directions of RECEIVE Transactions (From Physical Platform to Virtual Platform):

1. Write Transaction:
Physical platform writes a transaction to virtual platform:

The AMBA BUS master of physical platform writes a transaction to virtual platform slave. The AMBA BUS side of XTOR writes HDR and writes data PAYLOAD into internal memory and request PCI BUS side of XTOR to put this packet to Rx buffer.

The device driver will control virtual platform proxy to read HDR and PAYLOAD from Rx buffer. Then the virtual platform proxy writes data PAYLOAD to virtual platform and completes a write transaction.

2. Read Transaction:
Physical platform requests a read transaction from virtual platform:

The AMBA BUS master of physical platform sends a read request transaction to virtual platform slave. The AMBA BUS side of XTOR writes HDR into internal memory and request PCI BUS side of XTOR to put this packet to Rx buffer.

The device driver controls then virtual platform proxy to read HDR from Rx buffer. Then the virtual platform proxy reads back data from virtual platform and puts data PAYLOAD into Rx buffer. The device driver controls PCI BUS side of XTOR to read PAYLOAD from Rx buffer and stores then into internal memory.

The PCI BUS side of XTOR reads PAYLOAD from Rx buffer and requests AMBA BUS side of XTOR to complete the read transaction.

Transaction address RxDES has to be prepared first, and then packet address to store packet has to be prepared and then RxDES.tdes0.own has to be set into “1′b1” to indicate XTOR of physical platform that Rx packet is prepared ready to receive. After transaction is completed, XTOR of physical platform writes back status into reception destination address RxDES.tdes0.

A key factor of the present invention is that by the connection between virtual and physical platform in both directions the design and verification of integrated circuits is significantly accelerated. Real Time Operation System (RTOS) of TLM/CX virtual platform can access physical platform design realistically and therefore the physical platform verification is accelerated. Another important item is that Real Time Operation System (RTOS) on RTUCA physical platform can access TLM/CX virtual platform design early without waiting RTUCA design implemented by FPGA/CHIP and therefore the RTUCA design time and FPGA/CHIP cost are reduced.

FIG. 12 illustrates a flowchart of a method invented to combine a RTL physical platform and a TLM virtual platform. Step 120 describes the provision of a hybrid system comprising a virtual platform proxy connected to a PC-system having a memory, and of a packet transactor, wherein the packet transactor is connected to a test bench via a on-chip bus. Step 121 illustrates writing a transaction from the virtual platform to the on-chip bus and step 122 shows reading a transaction by the virtual platform proxy from the on-chip Bus.

While the invention has been particularly shown and described with reference to the preferred embodiments thereof, it will be understood by those skilled in the art that various changes in form and details may be made without departing from the spirit and scope of the invention.

What is claimed is:

1. A system combining a Register Transfer Level/Cycle Accurate (RTUCA) physical platform with a Transaction Level Modeling/Cycle Approximate (TLM/CX) virtual platform providing an interface between both physical and virtual platforms in both directions in order to enable integration of new circuit designs in virtual platform to run TLM simulations and to add existent semiconductor soft properties (IP) to physical platform to run hardware acceleration is comprising:
a physical bus connecting a device driver on the virtual platform with a packet transactor on the physical platform;
said device driver connected further with a virtual platform proxy driver on the virtual platform;
said virtual platform proxy;
said packet transactor on the physical platform translating RTUCA bus protocol to TLM/CX packet format.

2. The system of claim 1 wherein said packet transactor is embedded in a PCI HW Emulator card

3. The system of claim 2 wherein said HW Emulator card is a Field Programmable Gate Array.

4. The system of claim 1 wherein said packet transactor is a soft intellectual property core.

5. The system of claim 1 wherein said packet transactor comprises a first means of memory, and a second means of memory, being each connected to a Physical Bus/BUS Independent Interface Wrapper and to a on-chip Bus/Bus independent Interface wrapper.

6. The system of claim 5 wherein said first means of memory is a PC2DUT dual port SSRAM memory being connected via a Bus independent memory Interface to said Physical Bus Wrapper and via a Bus independent memory Interface to said on-chip Bus Independent Interface wrapper.

7. The system of claim 5 wherein said second means of memory is a DUTPC dual port SSRAM memory being connected via a Bus independent memory Interface to said Physical Bus Wrapper and via a Bus independent memory Interface to said on-chip Bus Independent Interface wrapper.

8. The system of claim 1 wherein said packet transactor comprises a finite state machine for receiving transactions and a finite state machine for transmitting transactions.

9. The system of claim 1 wherein said virtual platform proxy comprises a packet decoder, a packet encoder, a transactor driver front end and a virtual component used to switch data between virtual platform and Transmission/Reception buffers in said device driver, wherein the virtual component comprises a virtual master block and more than one virtual slaves.

10. The system of claim 1 wherein said device driver comprises a transaction transmission buffer and a transaction reception buffer, wherein both of which are connected to said virtual platform proxy, a transaction transmission descriptor and a transaction reception descriptor, a PCI device driver interface, and a character device driver interface, wherein the transaction transmission descriptor and the transaction transmission buffer are used to switch data from the virtual platform to the physical platform, wherein the transaction reception descriptor and the transaction reception buffer are used to switch data from physical platform to virtual platform.

11. A method to combine a RTL physical platform and a TLM virtual platform comprising the following steps:
(1) providing a hybrid system comprising a virtual platform proxy connected to a PC-system having a memory, and a packet transactor, wherein the packet transactor is s connected to a test bench via an on-chip bus;
(2) writing a transaction from the virtual platform to the on-chip bus; and
(3) reading a transaction by the virtual platform proxy from the on-chip Bus.

12. The method of claim 11 wherein said writing a transaction from the virtual platform to the on-chip bus comprises the steps of:
preparing and storing a transmission packet from the virtual platform in a system memory of said PC-system and initiate a physical bus wrapper of the packet transactor to read the transmission packet from the PC-system memory;
reading data of the transmission packet by the physical bus wrapper from the PC-system memory, convert the transmission packet and put the data to a Transmission Direct Memory Access block;
writing the transmission packet by the Direct Memory Access block to a Transmission FIFO block;
storing transmission packet in a on-chip memory of the Transmission FIFO block; and
reading transmission packet out of the Transmission FIFO block and generating an on-chip Bus interface protocol by an on-chip bus wrapper.

13. The method of claim 11 wherein said reading a transaction by the virtual platform proxy from the on-chip Bus comprises the steps of:
analyzing an on-chip bus interface protocol and writing a reception packet to the Reception FIFO by an on-chip Bus Wrapper block;
storing the reception packet from the on-chip Bus Wrapper in a on-chip memory of the Reception FIFO block and reading out to a Reception Direct Memory Access by a Reception DMA block;
writing the reception packet to a physical bus wrapper by Reception DMA block; and
writing reception packet to the PC-system memory and converting reception block to a DMA interface format by a physical bus wrapper block.

14. The method of claim 1 wherein said packet transactor is fully compliant with an AMBA Specification revision 2.0 released by ARM Corporation and with PCI Local Bus Specification 2.3 standard.
